(19) United States
(12) Patent Application Publication
(10) Pub. No.: US 2010/0131088 A1
(43) Pub. Date: May 27, 2010

(54) AUDIO SIGNAL PLAYBACK APPARATUS, METHOD, AND PROGRAM

(75) Inventors: Yuki Kawaguchi, Tokyo (JP); Yukihiko Mogi, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/619,843

(22) Filed: Nov. 17, 2009

(30) Foreign Application Priority Data
Nov. 21, 2008 (JP) 2008-298030

(51) Int. Cl. G06F 17/00

(52) U.S. Cl. 700/94

(57) ABSTRACT

An audio signal playback apparatus includes a bitstream parser configured to perform bitstream parsing on each frame of a compressed audio signal and to analyze the start address of a next frame, a frame information table configured to store the frame information so as to be associated with an entry number, an address information table configured to store the entry number of the frame information table and the start address so as to be associated with a frame number, and a signal playback unit configured to generate a playback signal on the basis of the frame information stored in the frame information table. When special playback is performed, the signal playback unit refers to the address information table and, when frame information corresponding to a designated frame number is stored in the frame information table, acquires the frame information from the frame information table.

### BACKGROUND OF THE INVENTION

1. Field of the Invention

The present invention relates to audio signal playback apparatuses, methods, and programs which realize fast-forward/fast-rewind processing in playback of compressed audio signals recorded in formats in which frame length information is not included in header information.

2. Description of the Related Art

The MPEG (Moving Picture Expert Group) audio standards have been employed to encode audio signals. The MPEG audio standards provide several schemes such as the standardized MPEG-2 AAC (Advanced Audio Coding) scheme specified in ISO/IEC 13818-7 and the extended MPEG-4 AAC scheme specified in ISO/IEC 14496-3. Hereinafter, the MPEG-2 AAC audio standard and the MPEG-4 AAC audio standard are simply referred to as AAC audio standards. FIG. 7 is a block diagram illustrating a configuration of a decoding apparatus which conforms to the AAC standards. In FIG. 7, a bitstream information parsing unit 101 parses an input bitstream and creates information to be provided to a Huffman decoding unit 102, an M/S (middle side stereo) unit 113, an intensity/coupling unit 115, a TNS (temporal noise shaping) unit 116, an IMDCT (inverse-modified discrete cosine transform) unit 117, and a gain control unit 118.

The Huffman decoding unit 102 performs Huffman decoding on the basis of the information received from the bitstream information parsing unit 101 to obtain quantized spectral data and scale-factor information. At this time, the start address of the next frame in the input bitstream is determined.

A dequantizing unit 111 dequantizes the quantized spectral data received from the Huffman decoding unit 102 and obtains dequantized spectral data. A normalizing unit 112 normalizes the dequantized spectral data in accordance with the scale factor and obtains normalized spectral data.

The M/S stereo unit 113 and the intensity/coupling unit 115 perform processing for reconstructing data encoded in accordance with a stereo correlation technique. A predicting unit 114 performs predictive coding. The TNS unit 116 reconstructs the spectral data in which quantization noise has been controlled in time. The IMDCT unit 117 converts spectral data in the frequency domain into waveform data in the time domain. The gain control unit 118 is used for an SSR (scaleable sampling rate) profile only and performs processing for reconstructing a signal which has been divided into four equally-spaced frequency bands.

Decoded PCM (pulse-code modulation) data obtained through the above series of processing is output.

In decoding processing performed in accordance with the AAC standards, the processing from the acquisition of quantized spectral data and scale factor information by Huffman decoding performed by the Huffman decoding unit 102, to the determination of the start address of the next frame in an input bitstream is herein referred to as bitstream parsing. In addition, components for performing bitstream parsing are herein simply referred to as a bitstream parser 100.

The quantized spectral data, scale factor data, and information to be provided to the M/S stereo unit 113, the intensity/coupling unit 115, the TNS unit 116, the IMDCT unit 117, and the gain control unit 118, which are generated by bitstream parsing, are herein all together referred to as frame information.

Further, processing from the dequantization to the PCM output, which are performed by the components from the dequantizing unit 111 through the gain control unit 118 upon receiving the frame information, is herein referred to as bitstream decoding. In addition, the components for performing bitstream decoding are herein simply referred to as a bitstream decoder 110.

The ratio of the processing times of bitstream decoding and bitstream parsing ranges from approximately 7:3 to approximately 6:4.

Compressed audio data including AAC compressed audio data has a data structure constituted by a series of frames, and each frame contains header information and compressed audio signal data.

There are three types of AAC formats including ADIF (audio data interchange format) having a header, ADTS (audio data transport stream) having headers, and raw data without a header. In either of the above formats, the length of one frame is variable.

In ADTS, header information contains information on the frame length. Thus, high-speed fast-forward/fast-reverse may be achieved by simply acquiring and analyzing header information of individual frames, by using a method disclosed in, for example, Japanese Unexamined Patent Application Publication No. 2003-6992.

However, in ADIF, header information does not contain information on the frame length of each frame. Thus, it is not possible to acquire the start address of the next frame by simply acquiring and analyzing the header information of the current frame. The start address of the next frame may not be determined until bitstream parsing on the entire current frame is completed.

Therefore, when fast-forwarding/fast-reversing is performed, it is necessary to perform bitstream parsing not only on header information but also on the entire frame, which hinders high-speed fast-forward/fast-reverse processing.

In addition, in the case of raw data, which does not have a header, the start address of the next frame is not determined until bitstream parsing on the entire current frame is completed, and thus high-speed fast-forward/fast-reverse processing may not be achieved.

Japanese Unexamined Patent Application Publication No. 2002-41095 discloses a device for playing back a compressed audio signal in which frame length information is not contained in header information. The disclosed device enables high-speed fast-forward/fast-reverse processing of a compressed audio signal in which frame length information is not contained in header information. In the device, when playback of a compressed audio signal is performed for the first time, the frame number and frame start address of a frame which has been played back are stored as frame position information in a frame position information table. When a fast-forward/fast-reverse instruction is received during playback of the compressed audio signal for the second time and thereafter, the frame position information table is referred to so that the read start address of a destination frame for the fast-forward/fast-reverse is determined.

However, in the fast-forward/fast-reverse technique according to Japanese Unexamined Patent Application Publication No. 2002-41095, frame position information of a compressed audio signal which has not been played back is not stored in the frame position information table. Thus, high-speed fast-forward/fast-reverse may not be realized. To overcome this shortcoming, a device disclosed in

Japanese Unexamined Patent Application Publication No. 2006-178179 performs the following processing in parallel with playback of a compressed audio signal having a frame structure in which frame length information is not included in header information. First, frame position information of frames to be played back after a frame being currently played back is acquired and then stored in a frame position information table. When a fast-forward instruction is received, the position of a fast-forward destination frame is determined on the basis of the frame position information stored in the frame position information table.

Referring to FIG. 8, fast-forward/fast-reverse processing using a compressed audio signal playback device disclosed in Japanese Unexamined Patent Application Publication No. 2006-178179 will be briefly described.

The device includes a signal playback unit 200, a position information acquiring unit 210, and a frame position information table 220. The signal playback unit 200 and the position information acquiring unit 210 operate in parallel.

The position information acquiring unit 210 reads an input bitstream to perform bitstream parsing and successively acquires only frame start positions to be stored in the frame position information table.

When a fast-forward/fast-reverse instruction is sent to a read start address determinator 201, the read start address determinator 201 refers to the frame position information table 220 to acquire the start address of a fast-forward/fast-reverse destination frame as a read start address. The read start address determinator 201 then notifies a bitstream parser 202 of the read start address.

The bitstream parser 202 in the signal playback unit 200 acquires a bitstream input on the basis of the read start address and performs bitstream parsing. A bitstream decoder 203 receives frame information generated by the bitstream parser 202 and performs bitstream decoding to output a PCM signal.

However, in the playback device according to Japanese Unexamined Patent Application Publication No. 2006-178179, it is necessary to provide a bitstream parser in each of the signal playback unit 200 and the position information acquiring unit 210, which causes redundant circuit configurations. In addition, the position information acquiring unit 210 is not provided with a function of holding information on a bitstream-parsed frame. Therefore, the signal playback unit 200 has to perform bitstream parsing again on a frame to be played back, after acquiring the frame start address information from the frame position information table 220.

### SUMMARY OF THE INVENTION

As described above, playback devices according to the related art involve redundant circuit configurations and complicated signal processing to perform special playback such as fast-forward/fast-reverse on compressed audio signal data in which frame length information is not included in header information.

The present invention has been made in view of the above circumstances. Accordingly, there is a need for an audio signal playback apparatus, an audio signal playback method, and an audio signal playback program which realize rapid processing of special playback such as fast-forward/fast-reverse with a simple configuration.

An audio signal playback apparatus according to an embodiment of the present invention includes a bitstream parser configured to perform bitstream parsing on a compressed audio signal recorded in a format in which frame length information is not included in header information, on a frame by frame basis to generate frame information and to analyze the start address of a next frame, a frame information table configured to store the frame information so as to be associated with an entry number, an address information table configured to store the entry number of the frame information table and the start address so as to be associated with a frame number, and a signal playback unit configured to generate a playback signal on the basis of the frame information stored in the frame information table. When special playback is performed, the signal playback unit refers to the address information table and, when frame information corresponding to a frame number designated for the special playback is stored in the frame information table, acquires the frame information from the frame information table.

An audio signal playback method according to an embodiment of the present invention includes the steps of performing bitstream parsing on a compressed audio signal on a frame by frame basis which is recorded in a format in which frame length information is not included in header information, generating frame information and storing the frame information in a frame information table so as to be associated with an entry number, analyzing the start address of a next frame and storing the entry number of the frame information table and the start address in the address information table so as to be associated with a frame number, and when special playback is performed, referring to the address information table, and when frame information corresponding to a frame number designated for the special playback is stored in the frame information table, acquiring the frame information from the frame information table and generating a playback signal.

A program according to an embodiment of the present invention causes an information processing apparatus to execute processing including the steps performing bitstream parsing on a compressed audio signal on a frame by frame basis which is recorded in a format in which frame length information is not included in header information, generating frame information and storing the frame information in a frame information table so as to be associated with an entry number, analyzing the start address of a next frame and storing the entry number of the frame information table and the start address in the address information table so as to be associated with a frame number, and when special playback is performed, referring to the address information table, and when frame information corresponding to a frame number designated for the special playback is stored in the frame information table, acquiring the frame information from the frame information table and generating a playback signal.

According to an embodiment of the present invention, in a case of special playback, the address information table is referred to. When frame information corresponding to a frame number designated for the special playback is stored in the frame information table, the frame information is acquired from the frame information table so that a playback signal is generated. This arrangement makes it possible to reduce the number of bitstream parsers to one, whereas at least two bitstream parsers are necessary according to the related art. In addition, it is also possible to make effective used of frame information stored in the frame information table, allowing rapid processing of special playback such as fast-forward/fast-reverse with a simple configuration.

### BRIEF DESCRIPTION OF THE DRAWINGS

FIG. 1 is a block diagram illustrating a configuration of a playback apparatus according to an embodiment of the present invention;

FIG. 2 illustrates an example of an address information table;

FIG. 3 illustrates another example of an address information table;

FIG. 4 illustrates an example of a frame information table;

FIG. 5 is a flowchart illustrating playback of compressed data equivalent to one frame to be performed in fast-forward/fast-reverse;

FIG. 6 illustrates a modification example of a frame information table;

FIG. 7 is a block diagram illustrating a configuration of a decoding apparatus conforming to the AAC standards; and

FIG. 8 is a block diagram illustrating a configuration of a compressed audio signal playback apparatus according to the related art.

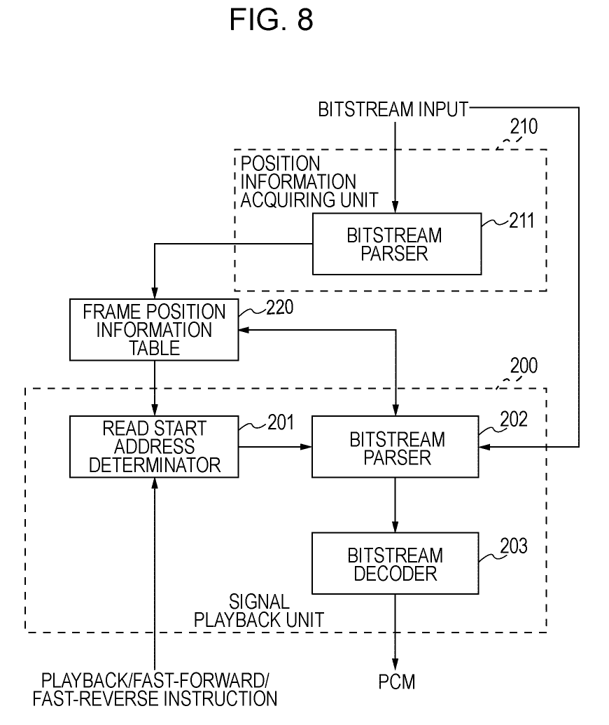

### DESCRIPTION OF THE PREFERRED EMBODIMENTS

In the following, preferred embodiments of the present invention will be described in detail with reference to the drawings in the following sequence.

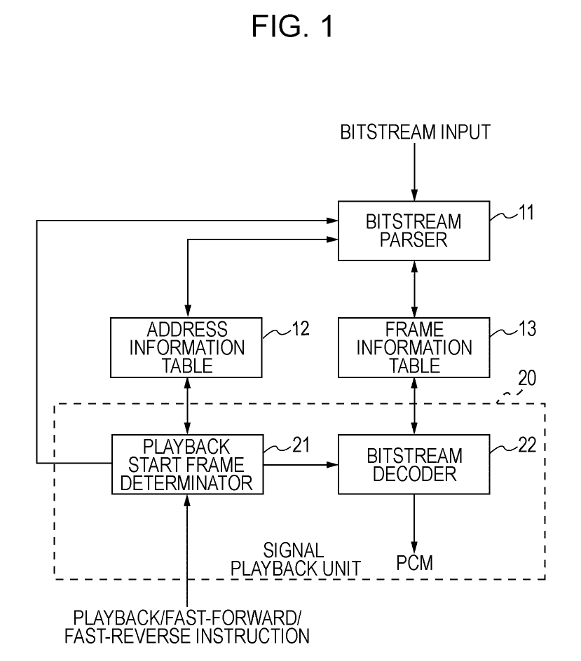

1. Entire configuration (FIG. 1)

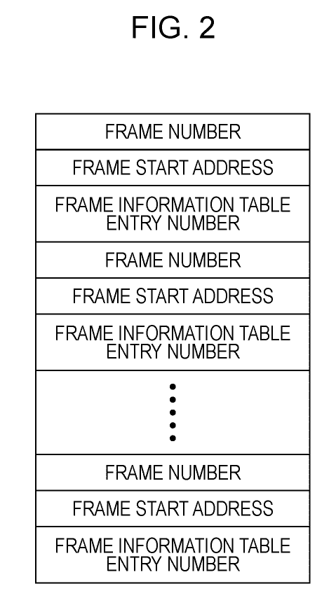

2. Address information table and frame information table (FIG. 2 to FIG. 4)

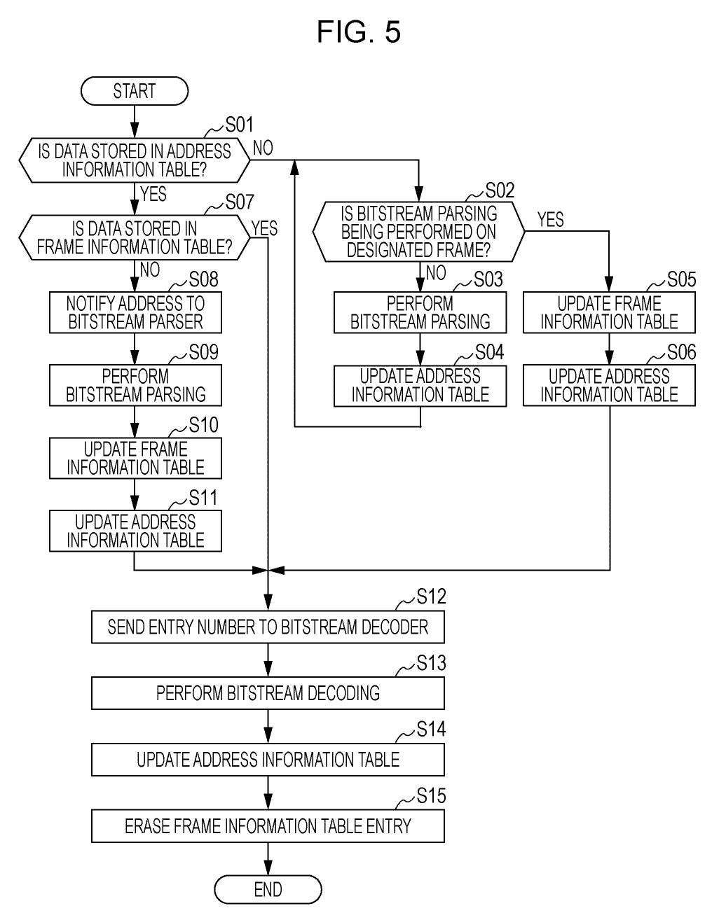

3. Fast-forward/fast-reverse processing (FIG. 5)

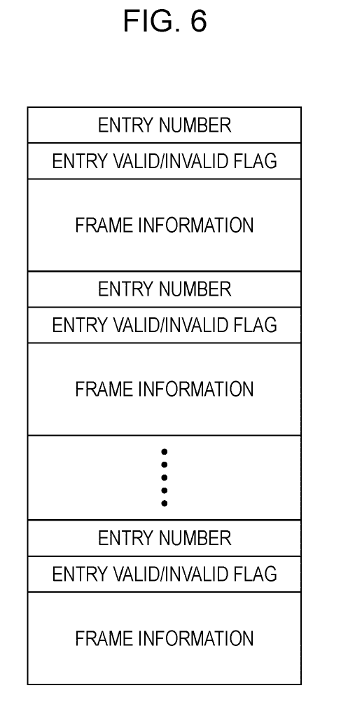

4. Modification example (FIG. 6)

### [Entire Configuration]

An audio signal playback apparatus according to an embodiment of the present invention performs special playback such as fast-forward and fast-reverse on a compressed audio signal recorded in a format in which frame length information is not included in header information. Examples of such a format include ADIF (audio data interchange format) in the AAC (Advanced Audio Coding) standard, row data and so forth.

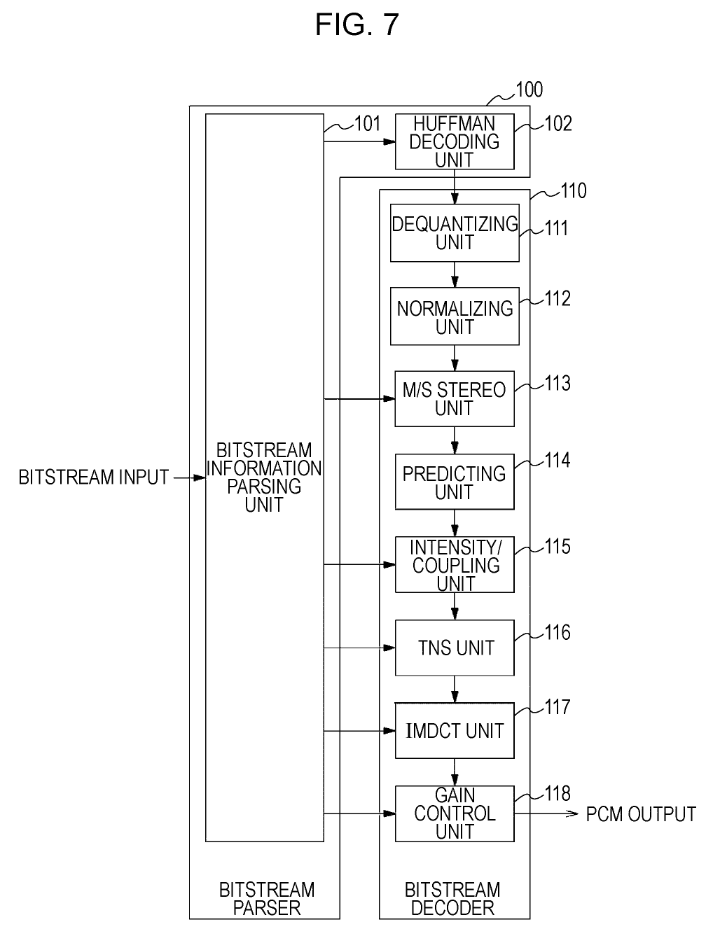

FIG. 1 is a block diagram illustrating a configuration of a playback apparatus according to an embodiment of the present invention. The playback apparatus includes a bitstream parser 11, an address information table 12, a frame information table 13, and a signal playback unit 20. The signal playback unit 20 and the bitstream parser 11 operate in parallel. The ratio of processing times of the signal playback unit 20 and the bitstream parser 11 ranges from approximately 7:3 to approximately 6:4. The signal playback unit 20 has a playback start frame determinator 21 and a bitstream decoder 22. Note that the bitstream parser 11 and the bitstream decoder 22 correspond to the bitstream parser 100 and the bitstream decoder 110, respectively, which are illustrated in FIG. 7.

The bitstream parser 11 performs bitstream parsing on each frame in an input compressed bitstream to obtain frame start addresses and stores the frame start addresses in the address information table 12. At the same time, when there is a free space in the frame information table 13, the bitstream parser 11 stores frame information obtained by the bitstream parsing in the frame information table 13.

The address information table 12 stores entry numbers in the frame information table 13 and frame start position addresses to be associated with frame numbers. The frame information table 13 stores frame information to be associated with the entry numbers. Note that a frame start address refers to recording source information indicating the start position of data in an input frame. In addition, frame information refers to information generated through bitstream parsing, including quantized spectral data, scale-factor information data, and information to be provided to the M/S stereo unit 113, the intensity/coupling unit 115, the TNS unit 116, the IMDCT unit 117 and the gain control unit 118.

The playback start frame determinator 21 determines the frame number of the next frame in normal playback and determines the frame number of a jump destination frame in special playback such as fast-forward playback and fast-reverse playback. In addition, when data is to be played back from a frame located at a middle point of the data, the playback start frame determinator 21 designates a cue playback start position to determine the frame number of the frame.

After determining the frame number of the frame to be played back, the playback start frame determinator 21 checks the address information table 12 to determine whether or not there is data corresponding to the determined frame number. Specifically, the playback start frame determinator 21 determines whether or not the frame start address corresponding to the determined frame number is stored in the address information table 12. If the frame start address is not stored in the address information table 12, the playback start frame determinator 21 instructs the bitstream parser 11 to continue bitstream parsing until the frame start address is acquired. When the bitstream parser 11 completes bitstream parsing on the playback start frame, the corresponding frame information is written to the frame information table 13 and the address information table 12 is updated.

On the other hand, if there is the data corresponding to the determined frame number in the address information table 12, the playback start frame determinator 21 checks the content of the data to determine whether frame information corresponding to the frame number is stored in the frame information table 13. When the frame information is stored in the frame information table 13, the playback start frame determinator 21 notifies the bitstream decoder 22 of the entry number of the frame information. On the other hand, if the frame information is not stored in the frame information table 13, the playback start frame determinator 21 notifies the bitstream parser 11 of the corresponding frame start address stored in the address information table 12 so as to cause the bitstream parser 11 to perform bitstream parsing. Note that the size of an entry of the frame information table 13, although depending on the application, is approximately 36 KB in the case of playback of 5.1 channel data using a compressed audio signal playback device conforming to the AAC standards. The bitstream decoder 22 receives the entry number in the frame information table 13 from the playback start frame determinator 21 and acquires the frame information from the frame information table 13 on the basis of the received entry number. Then, the bitstream decoder 22 starts decoding on the basis of the acquired frame information and outputs a PCM signal.

As described above, in the present embodiment, frame start addresses are stored in the address information table 12 and, at the same time, frame information of frames which have been bitstream-parsed by the bitstream parser 11 is also stored in the frame information table 13. Then, the bitstream decoder 22 generates a PCM signal using the frame information stored in the frame information table 13.

Thus, with the playback device according to the present embodiment, it is not necessary to prepare two bitstream parsers in order to repeat bitstream parsing, which can simplify circuit configurations.

On the other hand, a playback device according to the related art is not capable of holding the frame information of a bitstream-parsed frame. Thus, the frame information obtained by bitstream parsing is discarded. Therefore, it is necessary for a signal playback unit according to the related art to acquire data which has not undergone bitstream parsing on the basis of frame start address information and to prepare two bitstream parsers in order to repeat bitstream parsing on the data. In addition, in a case where playback processing using the playback device according to the related art is implemented as a program and realized using a single CPU, it is necessary to serially perform the processing of the signal playback unit 200 and the processing of the position information acquiring unit 210. Consequently, in playback devices according to the related art, such redundant bitstream parsing increases the number of execution cycles and power consumption.

### [Address Information Table and Frame Information Table]

In the following, the address information table 12 and the frame information table 13 will be described. FIG. 2 illustrates an example of the address information table 12. The address information table 12 has fields for individual frames. Each of the fields includes a frame number, a frame start address, and a frame information table entry number. The frame information table entry number and the frame start address are stored so as to be associated with the frame number. The frame number herein refers to a number corresponding to a frame of a compressed audio signal. The frame start address refers to a recording start position in the recording source of the compressed audio signal. In addition, the frame information table entry number refers to a number indicating a storage location in the frame information table 13.

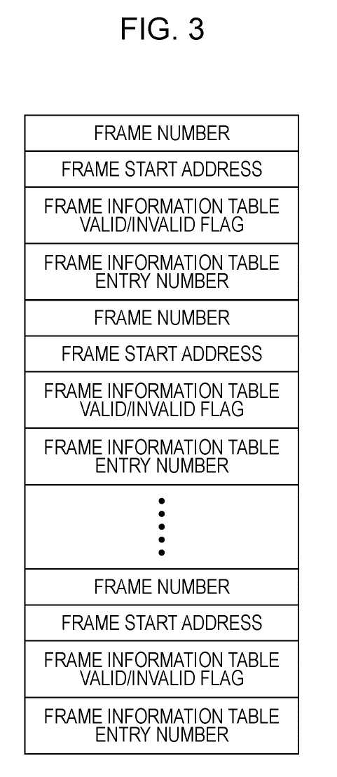

It is preferred that fields of frame information table entry numbers are also used as frame information table valid/invalid flags, as illustrated in FIG. 3. This allows the signal playback unit 20 to easily determine the presence or absence of frame information without checking the frame information table 13.

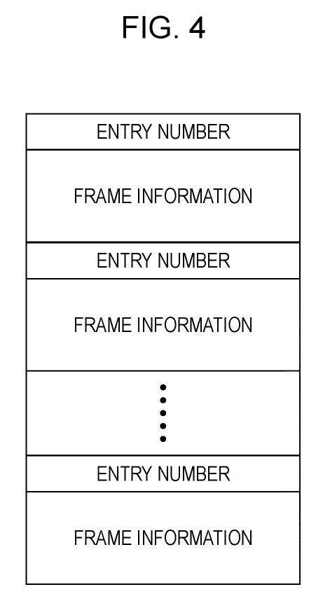

FIG. 4 illustrates an example of the frame information table 13. The frame information table 13 stores entry numbers and frame information so as to be associated with each other.

### [Fast-Forward/Fast-Reverse Processing]

Now, a procedure of fast-forward/fast-reverse processing which is performed by employing an embodiment of the present invention will be described with reference to FIG. 5. In the following description, it is assumed that a playback apparatus has the address information table illustrated in FIG. 3 and the frame information table illustrated in FIG. 4.

Upon receiving a fast-forward/fast-reverse instruction, the playback start frame determinator 21 of the signal playback unit 20 refers to the address information table 12 to determine the frame number of a jump destination.

At Step S01, the playback start frame determinator 21 determines whether or not the frame information entry number corresponding to the frame number of the jump destination frame is stored in the address information table 12. If it is determined that the frame information entry number is not stored in the address information table 12, the procedure proceeds to Step S02. On the other hand, if it is determined that the frame information entry number is stored in the address information table 12, the procedure proceeds to Step S07.

At Step S02, the bitstream parser 11 determines whether or not bitstream parsing is currently performed on the frame corresponding to the frame number of the jump destination frame. If it is determined that bitstream parsing is not currently performed on the jump destination frame, the procedure proceeds to Step S03. If it is determined that bitstream parsing is currently performed on the jump destination frame, the procedure proceeds to Step S05.

At Step S03, the bitstream parser 11 performs bitstream parsing on a frame which does not correspond to the frame number of the jump destination frame.

At Step S04, the bitstream parser 11 analyzes the frame start address of the next frame and stores the frame start address in the address information table 12 so as to be associated with a frame number. Then, the bitstream parser 11 updates the address information table 12.

At Step S05, the bitstream parser 11 performs bitstream parsing on the frame corresponding to the frame number of the jump destination. Then, the bitstream parser 11 stores frame information obtained as a result of the bitstream parsing in the frame information table 13 so as to be associated with an entry number and updates the frame information table 13.

At Step S06, the bitstream parser 11 analyzes the start address of the next frame. The bitstream parser 11 then stores the frame start address in the address information table 12 so as to be associated with a frame number and updates the address information table 12. At this time, the bitstream parser 11 sets a field of the frame information table valid/invalid flag corresponding to the frame number of the jump destination frame to be valid (ON). When the update of the address information table 12 is completed, the procedure proceeds to Step S12.

In short, in Step S02 through Step S06, the bitstream parser 11 performs bitstream parsing on frames until reaching the one corresponding to a frame number designated by the playback start frame determinator 21 to parse the bitstream until the frame start address of the next frame. Then, the bitstream parser 11 updates the address information table 12 and the frame information table 13.

At Step S07, the playback start frame determinator 21 refers to the address information table 12 to check the field content of the frame information table valid/invalid flag corresponding to the frame number of the jump destination frame. This checking allows the playback start frame determinator 21 to determine whether frame information is stored in the address information table 12. If it is determined in Step S07 that the frame information corresponding to the frame number of the jump destination frame is not stored in address information table 12, the procedure proceeds to Step S08. At this point, an invalid value of the frame information valid/invalid flag indicates that frame information of the jump destination frame is not stored in the frame information table 13 while the frame start address of the jump destination frame has been determined. If it is determined in Step S07 that frame information corresponding to the frame number of the jump destination frame is stored, the procedure proceeds to Step S12. In this case, the processing speed can be increased by the time necessary for storing frame information in the frame information table 13.

At Step S08, the playback start frame determinator 21 reads the frame start address of the jump destination frame from the address information table 12 and notifies the bitstream parser 11 of the read frame start address.

At Step S09, the bitstream parser 11 reads the jump destination frame from the recording source on the basis of the frame start address notified by the playback start frame determinator 21.

At Step S10, the bitstream parser 11 performs bitstream parsing to generate frame information of the jump destination frame. The bitstream parser 11 stores the frame information in the frame information table 13 so as to be associated with an entry number and then updates the frame information table 13.

At Step S11, the bitstream parser 11 stores the frame start address of the next frame in the address information table 12 so as to be associated with a frame number and then updates the address information table 12. At this time the bitstream parser 11 sets the field of the frame information valid/invalid flag corresponding to the frame number of the jump destination frame to be valid (ON).

At Step S12, the playback start frame determinator 21 reads the frame information table entry number of the jump destination frame from the address information table 12 and notifies the bitstream decoder 22 of the entry number. That is, in Step S12, the frame information of the jump destination frame is retained in the frame information table 13.

At Step S13, the bitstream decoder 22 acquires the frame information of the jump destination frame from the frame information table 13 on the basis of the entry number received from the playback start frame determinator 21. The bitstream decoder 22 starts decoding on the jump destination frame to output a PCM signal.

Upon completion of the bitstream decoding of the jump destination frame, at Step S14, the bitstream decoder 22 sets the field of the frame information valid/invalid flag corresponding to the frame number to be invalid. The bitstream decoder 22 then updates the address information table 12.

At Step S15, the bitstream decoder 22 erases the frame information of the jump destination frame from the frame information table 13, so that the bitstream parser 11 can write frame information to the area in which the frame information of the jump destination frame has been stored.

Thus, in special playback such as fast-forward in a compressed audio signal playback apparatus, the signal playback unit 20 can effectively use bit information of frames partitioned by the bitstream parser 11. This permits reduction of the number of bitstream parsers to one, whereas at least two bitstream parsers are necessary in the related art, and thus the number of redundant circuits may be reduced.

Note that in Step S08, it is also possible that the playback start frame determinator 21 notifies the bitstream parser 11 of the frame number of the jump destination frame. Then, at Step S09, the bitstream parser 11 may acquire the frame start address corresponding to the frame number from the address information table 12 to read the compressed audio signal.

### [Modification Example]

FIG. 6 illustrates a modification example of the frame information table 13. This frame information table 13 is provided with a field of an entry valid/invalid flag for each entry. This entry valid/invalid flag is set to be invalid when bitstream decoding in the signal playback unit 20 is completed. The bitstream parser 11 sequentially overwrites data in a field corresponding to an entry number for which the entry valid/invalid flag is set to be invalid. Thus, the bitstream parser 11 overwrites data by checking the entry valid/invalid flag to determine whether writing of data is permitted. This reduces the time necessary for erasing data, realizing high speed updating of the frame information table 13.

In the foregoing, a technique of playing back a compressed audio signal in an AAC format has been described. This technique can be applied to compressed audio signal processing which can be divided into two parts. The first part is processing for in which information in an entire compressed audio signal is analyzed to determine the length of each frame to parse the information. The second part is processing for generating a final output signal using the parsed information. These processing parts enable fast-forward/fast-reverse playback and cue playback of a compressed audio signal in a format in which frame length information is not included in header information.

Further, the above compressed audio signal playback apparatus can be constructed using a computer device or the like, using a program to be executed by a CPU (central processing unit), a DSP (digital signal processor), or the like. In this case, the total number of execution cycles necessary for the execution of the program is reduced by 23.1% to 28.6%. In addition, when the CPU or DSP has a mechanism, such as a sleep function, for stopping power supply during a period in which no operation is performed, the use of this technique with reduced execution cycles can realize reduction of poser consumption.

The present application contains subject matter related to that disclosed in Japanese Priority Patent Application JP 2008-298030 filed in the Japan Patent Office on Nov. 21, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An audio signal playback apparatus comprising:
a bitstream parser configured to perform bitstream parsing on a compressed audio signal on a frame by frame basis to generate frame information, the compressed audio signal being recorded in a format in which frame length information is not included in header information, and to analyze the start address of a next frame;
a frame information table configured to store the frame information so as to be associated with an entry number;
an address information table configured to store the entry number of the frame information table and the start address so as to be associated with a frame number; and
a signal playback unit configured to generate a playback signal on the basis of the frame information stored in the frame information table,
wherein when special playback is performed, the signal playback unit refers to the address information table and, when frame information corresponding to a frame number designated for the special playback is stored in the frame information table, acquires the frame information from the frame information table.

2. The audio signal playback apparatus of claim 1,
wherein when frame information corresponding to the frame number designated for the special playback is not stored in the frame information table, the signal playback unit notifies the bitstream parser of the designated frame number, and
wherein the bitstream parser acquires a start address corresponding to the notified frame number from the address information table to read a compressed audio signal.

3. The audio signal playback apparatus of claim 2,
wherein the address information table stores a valid/invalid flag for the frame information corresponding to the entry number so as to be associated with the frame number, and
wherein the signal playback unit determines whether the frame information corresponding to the designated frame number is stored in the frame information table on the basis of the valid/invalid flag, and sets the valid/invalid flag to be invalid when the generation of the playback signal is completed.

4. The audio signal playback apparatus of claim 2,
wherein the frame information table stores a valid/invalid flag for frame information for each entry number,
wherein the signal playback unit sets the valid/invalid flag to be invalid when the generation of the playback signal is completed, and
wherein the bitstream parser overwrites a field corresponding to the entry number for which the valid/invalid flag is invalid.

5. An audio signal playback method comprising the steps of:
performing bitstream parsing on a compressed audio signal on a frame by frame basis, the compressed audio signal being recorded in a format in which frame length information is not included in header information;
generating frame information and storing the frame information in a frame information table so as to be associated with an entry number;
analyzing the start address of a next frame and storing the entry number of the frame information table and the start address in the address information table so as to be associated with a frame number; and
when special playback is performed, referring to the address information table, and when frame information corresponding to a frame number designated for the special playback is stored in the frame information table, acquiring the frame information from the frame information table and generating a playback signal.

6. A program causing an information processing apparatus to execute processing comprising the steps of:
performing bitstream parsing on a compressed audio signal on a frame by frame basis, the compressed audio signal being recorded in a format in which frame length information is not included in header information;
generating frame information and storing the frame information in a frame information table so as to be associated with an entry number;
analyzing the start address of a next frame and storing the entry number of the frame information table and the start address in the address information table so as to be associated with a frame number; and
when special playback is performed, referring to the address information table, and when frame information corresponding to a frame number designated for the special playback is stored in the frame information table, acquiring the frame information from the frame information table and generating a playback signal.
